(19) United States
(12) Patent Application Publication
(10) Pub. No.: US 2008/0060433 A1
(43) Pub. Date: Mar. 13, 2008

(54) Fuel deck filler and gauge

(76) Inventors: Bruce Adrian Coward, New Milton (GB); Penelope Ann Cambell, New Milton (GB)

Correspondence Address: MANELLI DENISON & SELTER PLLC, 7th Floor, 2000 M Street, N.W., Washington, DC, 20036-3307, US

(21) Appl. No.: 11/896,823

(22) Filed: Sep. 6, 2007

(30) Foreign Application Priority Data
Sep. 7, 2006 (GB) GB 0617630.9

(51) Int. Cl. G01F 23/30

(52) U.S. Cl. 73/313; 73/290 R

(57) ABSTRACT

The present invention relates to a deck filler and gauge 1. A plate 2 is provided for mounting against the surface of a boat, and plate 2 has an aperture 4 therein to receive a fuel nozzle. A projection 6 extends on one side of the plate 2 from the aperture for engagement with a fuel pipe.

A cap 5 is provided for sealing the aperture 4. A fuel gauge having a display 10 is provided adjacent said plate aperture.

### FIELD

The present invention relates to a fuel deck filler and gauge for use with boats.

### BACKGROUND

Most boats are re-fuelled by inserting a fuel delivery nozzle into a deck filler that is usually mounted on a deck or transom of a boat in a manner allowing connectivity with the tank. The fuel gauge is typically situated with the rest of the instrumentation, namely the cockpit region. The deck filler is therefore typically positioned some distance away from the fuel tank gauge. Because of this it is not normally possible for one person alone to view the fuel tank gauge whilst re-fuelling. Consequently the tank is often over-filled resulting in spillage of fuel in the water. This is messy, undesirable economically and leads to environmental problems, particularly locally.

The invention seeks to provide a solution to this problem.

### SUMMARY OF THE INVENTION

According to a first aspect of the present invention there is provided a deck filler and gauge comprising:

a) a plate for mounting against the surface of a boat, said plate having an aperture therein to receive a fuel nozzle and a projection extending on one side of the plate from the aperture for engagement with a fuel pipe,
b) a cap for sealing said aperture, and
c) a fuel gauge having a display adjacent said plate aperture.

Preferably said plate further comprising a window therein and said fuel gauge display is displayed through said window.

Preferably a housing is provided for said fuel gauge and display.

Preferably the plate is formed integral with the fuel gauge housing and projection, with the fuel gauge housing and projection on one side of the plate. Preferably the fuel gauge display is encapsulated in material behind a window.

Preferably the fuel gauge display has one or more LED displays, and said LED displays vary in brightness to compensate for ambient light levels.

Preferably the gauge display provides an indication of fuel level in percentage terms.

The fuel gauge may operate on digital standards. Alternatively the fuel gauge may measure voltage change across a resistor in series with a fuel tank variable resistor or device having a similar characteristic.

A second aspect of the invention relates to a fuel gauge for connection to an analogue fuel gauge system having a float controlled variable resistor or device having a similar characteristic in a fuel tank, said fuel gauge comprising a resistor for wiring in series said float controlled variable resistor, means to measure the voltage change across said resistor, and a display to display the voltage change as an indication of fuel level in a tank.

Preferably the resistor is a low value resistor, an amplifier is provided to amplify the voltage across the resistor, and a micro processor is provided to measure the amplified voltage. Preferably the micro processor has a memory to store maximum and minimum amplified voltage values representing the range of a fuel tank being full or empty. Preferably a given amplified voltage value is displayed as a percentage of said range.

The fuel gauge of the second aspect of the invention may form part of the deck filler and gauge of the first aspect of the invention.

### BRIEF DESCRIPTION OF THE FIGURES

An embodiment of the invention will now be described with reference to the accompanying drawings in which:

FIG. 1 shows a perspective view of a deck filler and gauge, and

FIG. 2 shows a schematic circuit diagram of a fuel gauge.

### DETAILED DESCRIPTION OF PREFERRED EMBODIMENTS

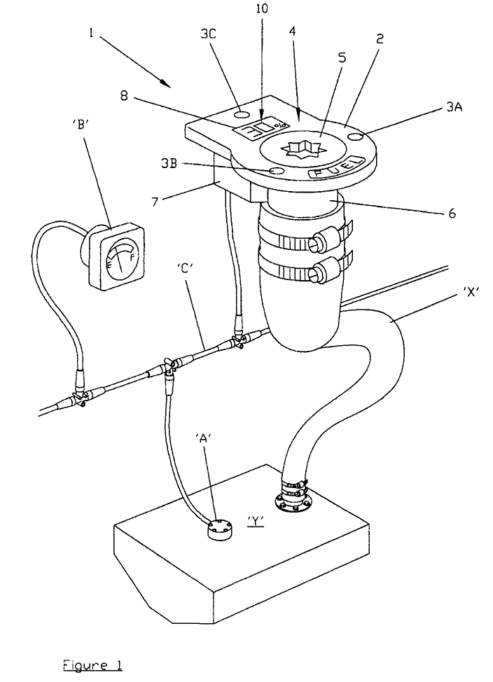

Referring to the FIG. 1 there is shown a deck filler and gauge 1. Deck filler and gauge 1 is in the form of a unitary casting of stainless steel. A planar “keyhole-shaped” plate 2 is provided for mounting against the surface of a boat with holes 3A, 3B, and 3C therein to receive screws or bolts to secure the plate 2 to a surface. Plate 2 has an aperture 4 therein, sealed by a removable cap 5, to receive a fuel nozzle. A cylindrical projection 6 extends from one side of the plate from the aperture for engagement with a fuel pipe “X” leading to a fuel tank “Y”.

A housing 7 is also provided on said one side of plate 2 to house a fuel gauge having a display 10. Display 10 is surrounded by and is displayed through a window 8 in the plate 2 adjacent aperture 4. The fuel gauge display 10 is encapsulated in material such as polyurethane behind the window so that is strong, waterproof and fuel proof, and does not mist up. The display may be encapsulated by a two part process using a clear and a black polyurethane encapsulation process that displaces internal air that can mist up the display window but allows the display to be visible. Display 10 has LED displays, and the LED displays vary in brightness to compensate for ambient light levels. The gauge display provides an indication of fuel level in tank “Y” in percentage terms.

The fuel gauge may operate on digital standards and receive information from a digital tank sender “A”. Tank sender “A” is of a type known in the art and measures the level of fuel in the tank and transmits that information as a digital data stream over the network trunk or main cable “C”. The fuel gauge with display 10 will also see this digital data and may effectively form a repeater of a master fuel gauge “B” which may typically be at the helm position in a boat.

In use a person can refuel a tank “Y” by inserting a fuel nozzle into aperture 4. The user can keep an eye on the level of fuel in the tank “Y” at any time at the point of filling by viewing the display 10 and prevent overflow and hence spillage of fuel.

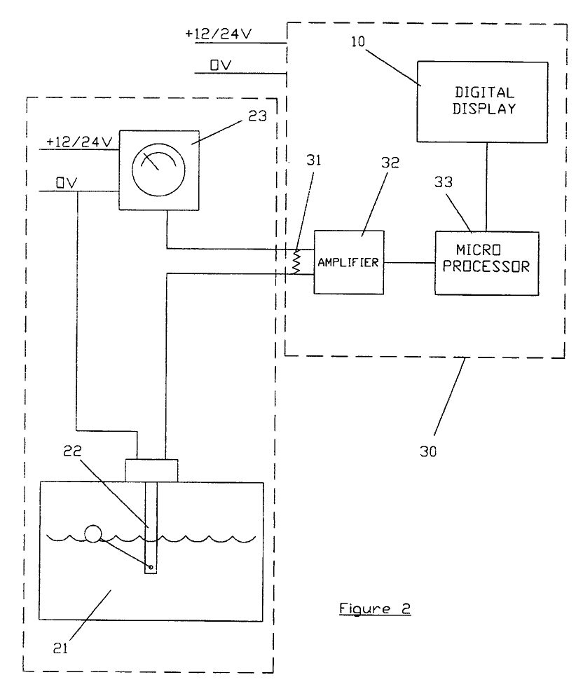

Instead of operating on digital standards, the fuel gauge with display 10 may be designed to work with a fuel tank having a float-controlled variable resistor as shown schematically in FIG. 2.

In FIG. 2 there is shown schematically in dotted lines a known fuel tank with gauge 20. A fuel tank 21 has a float-controlled variable resistor 22 which varies in resistance with the level of fuel in tank 21. An analogue current meter 23 is wired in series with the float-controlled variable resistor 22, and gives a read out the tank level proportional to the current. Such an arrangement is commonly used on boats.

A fuel gauge 30 is provided for connection to the fuel tank with gauge 20. Fuel gauge 30 has a low resistance current sensing resistor 31 which is wired in series with the float-controlled variable resistor 22. A small DC voltage is generated across the resistor 31 which is proportional to the current flowing through meter 23. The small voltage across the resistor 31 is amplified by an amplifier 32, and the amplified voltage fed to a micro processor 33 connected to display 10 (as shown in FIG. 1). Micro processor 33 measures the amplified voltage as it changes across the resistor 31, and display 10 displays the voltage change as an indication of fuel level in tank 21. As the current flowing through resistor 31 is inherently non-linear and can vary from type of variable resistor 21 and between same types of variable resistor, the microprocessor has to store a number of values and computations to display the tank level on display 10. These are built into the software within the micro processor.

The micro processor 33 may have a memory to store maximum and minimum amplified voltage values representing the range of a fuel tank being full or empty. A given amplified voltage value is displayed in display 10 as a percentage of the range.

As mentioned above, fuel gauge 30 may form part of the fuel gauge of FIG. 1. It could however be used effectively as a repeater of an existing fuel tank with gauge 20. Thus a second aspect of the invention relates to a fuel gauge for connection to an analogue fuel gauge system having a float controlled variable resistor in a fuel tank, said fuel gauge comprising a resistor for wiring in series said float controlled variable resistor, means to measure the voltage change across said resistor, and a display to display the voltage change as an indication of fuel level in a tank.

The invention may take a form different to that specifically described above. Further modifications will be apparent to those skilled in the art without departing from the scope of the present invention.

1. A deck filler and gauge comprising:
a) a plate for mounting against the surface of a boat, said plate having an aperture therein to receive a fuel nozzle and a projection extending on one side of the plate from the aperture for engagement with a fuel pipe,
b) a cap for sealing said aperture, and
c) a fuel gauge having a display adjacent said plate aperture.

2. A deck filler and gauge according to claim 1, wherein said plate further comprises:
a window therein and
said fuel gauge display is displayed through said window.

3. A deck filler and gauge according to claim 1, further comprising:
a housing provided for said fuel gauge and display.

4. A deck filler and gauge according to claim 3, wherein
the plate is formed integral with the fuel gauge housing and projection, with the fuel gauge housing and projection on one side of the plate.

5. A deck filler and gauge according to claim 1, wherein
the fuel gauge display is encapsulated in material behind a window.

6. A deck filler and gauge according to claim 1, wherein
the fuel gauge display has one or more LED displays, and
said LED displays vary in brightness to compensate for ambient light levels.

7. A deck filler and gauge according to claim 1, wherein
the gauge display provides an indication of fuel level in percentage terms.

8. A deck filler and gauge according to claim 1, wherein
the fuel gauge operates on digital standards.

9. A deck filler and gauge according to claim 1, wherein the fuel gauge measures a voltage change across a resistor in series with a fuel tank variable resistor or device having a similar characteristic.

10. A fuel gauge for connection to an analogue fuel gauge system having a float controlled variable resistor or device having a similar characteristic in a fuel tank, said fuel gauge comprising
a resistor for wiring in series said float controlled variable resistor,
means to measure the voltage change across said resistor
and a display to display the voltage change as an indication of fuel level in a tank.

11. A fuel gauge according to claim 10, wherein
the resistor is a low value resistor,
an amplifier is provided to amplify the voltage across the resistor, and
a micro processor is provided to measure the amplified voltage.

12. A fuel gauge according to claim 11, wherein the micro processor has a memory to store maximum and minimum amplified voltage values representing the range of a fuel tank being full or empty.

13. A fuel gauge according to claim 12, wherein
a given amplified voltage value is displayed as a percentage of said range.

14. (canceled)
